(19) United States
(12) Patent Application Publication
(10) Pub. No.: US 2005/0005599 A1
(43) Pub. Date: Jan. 13, 2005

(54) Hydraulic system having a variable displacement pump

(76) Inventor: Johannes Schmid, Schwaebisch Gmuend (DE)

Correspondence Address: JORDAN AND HAMBURG LLP, 122 EAST 42ND STREET, SUITE 4000, NEW YORK, NY, 10168, US

(21) Appl. No.: 10/915,140

(22) Filed: Aug. 10, 2004

Related U.S. Application Data
(63) Continuation of application No. PCT/EP03/02139, filed on Mar. 3, 2003.

(30) Foreign Application Priority Data
Mar. 6, 2002 (DE) 102 09 964.2

(51) Int. Cl. F16D 31/02

(52) U.S. Cl. 60/445

(57) ABSTRACT

For a hydraulic system having a variable displacement pump and consumer, a simple construction is proposed which, in addition to rapidly running up the variable displacement pump, also makes it possible to utilize the pump energy for heating purposes as a result of the arrangement, provided in the return line from the consumer, of a controlled pressure-regulating valve in combination with a throttling valve situated in the delivery-side feed line to the consumer and a pressure-relief valve situated in a manner short-circuiting the variable displacement pump.

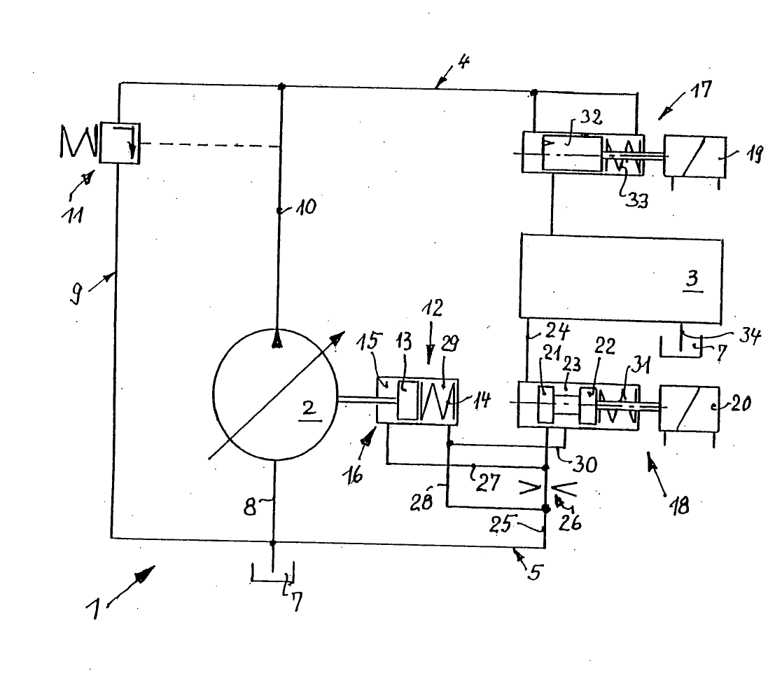

The invention relates to a hydraulic system having a variable displacement pump and a consumer, in particular an assembly of a motor vehicle, in accordance with the precharacterizing clause of claim 1.

A hydraulic system of the abovementioned type is known from DE 197 22 495 A1, in which system the variable displacement pump acts on a consumer, for example what is referred to as a CVT transmission used in vehicle drives, and in which system the variable displacement pump configured as a vane cell pump is loaded by an energy store configured as a spring when said pump is being run up, i.e. the swept volume is being increased, and, in the opposite direction to this, said pump is adjustable by applying pressure to a hydraulic adjusting device. Pressure is applied to the adjusting device via a branch line from the delivery-side connection of the variable displacement pump to the consumer, and, starting from the connection of the variable displacement pump to the consumer, there lie in this branch line an activatable flow-regulating valve and, downstream in the direction of the reservoir, a flow-control valve in the form of a throttle, and the pressure upstream of the throttle is used as control pressure for a control slide, by means of which control slide pressure is applied to the hydraulic adjusting device, as a function of the position of said control slide, by connecting it to the high pressure side of the pump in order to adjust the variable displacement pump in the direction of reducing the swept volume, or by means of which control slide the adjusting device is relieved of pressure, so that adjustment in the direction of running up is performed via the energy store, the pressure being relieved via a connection of the hydraulic adjusting device to the reservoir which is switched by the control slide.

In order to activate the variable displacement pump via the hydraulic adjusting device, the basic design of the system always requires a swept volume which lies above the swept volume to be received by the consumer, and this excess delivery amount is used in the known solution in accordance with the object to make sudden pressure increases in the consumer pressure line possible, in order to be able to satisfy sudden desired pressure requests from the consumer. For this purpose, it is possible to switch a modulating pressure to the flow regulating valve in such a way that the latter is closed irrespective of the prevailing minimum desired pressure at which the flow regulating valve opens, so that the excess swept volume cannot flow away to the reservoir via the throttle but is also fed to the consumer. The pressure drop associated with this switching of the flow regulating valve causes the control slide to be switched, so that the hydraulic adjusting device is relieved of pressure and it is possible to change over the variable displacement pump to a higher swept volume by means of the energy store configured as a spring. A construction of the depicted type is relatively complicated and costly and requires a relatively large excess swept volume, just for reasons of safety, so that corresponding losses result.

The invention is based on the object of designing a hydraulic system of the type mentioned in the introduction with as small pump losses as possible, in such a manner that the variable displacement pump can satisfy spontaneous requirements on the consumer side to increase the swept volume with a quick response.

This is achieved in a hydraulic system having the features of claim 1, according to which the pressure-regulating valve situated in the activation means of the hydraulic adjusting device is situated in the hydraulic circuit comprising variable displacement pump, consumer and reservoir, downstream of the consumer and ahead of the reservoir, so that it is possible to immediately detect requests on the consumer side or changes at the pressure-regulating valve and, possibly superimposed by system-relevant parameters in order to activate the pressure-regulating valve, also to convert them into an appropriate loading of the hydraulic adjusting device. In particular, it is possible in this way to design the maximum swept volume of the variable displacement pump to be the maximum demand of the consumer plus a very small excess amount, so that small losses result without the risk of functions being impaired, as excess amounts required for operation are not necessary beyond the maximum demand of the consumer and taking permissible leaks into consideration.

As it is additionally ensured in the solution according to the invention that, when a changeover is effected to a relatively large, in particular maximum swept volume, the flow out of the adjusting device via the pressure-regulating valve is largely without losses given appropriate dimensioning of the respective flow paths, it is also possible by means of the energy store to change over the pump to the maximum swept volume almost instantly, so that very high response speeds result.

Within the context of the invention, it is also possible to activate the pressure-regulating valve using information which indicates increased requirements of the consumer, in order to increase the response speed. It is thus possible, within the context of the invention, to use, for example, variables for vehicle dynamics, such as braking signals or the like, as indicators for imminent gear-shift operations which cause increased demand by the consumer to be expected, so that it is possible to use a reduction in the flow cross section from the consumer to the reservoir to increase the pressure in anticipation, with simultaneous loading of the adjusting device, in order to increase the swept volume of the variable displacement pump, by connecting the adjusting device to the reservoir and adjusting the variable displacement pump, which is made possible by said connection, by means of the energy store in the direction of a greater swept volume.

Within the context of the invention, it is possible to achieve these effects with minimum outlay, it possibly being proven expedient to provide a flow-control valve, in particular in the form of a controlled throttling valve, in the feed line to the consumer, which valve can also be activated independently of demands of the consumer, in order to be able to take, for example, temperature-related changes in the viscosity of the pressure medium or the like into consideration.

In particular, a throttling valve configured in this way can be used, within the context of the invention, with a pressure-relief valve situated so as to short-circuit the variable displacement pump, in order to operate the variable displacement pump with a swept volume raised above the basic delivery in conjunction with the pressure-relief valve as source of losses, without negative effects on the consumer and on the regulation of the variable displacement pump which is adapted in terms of basic delivery to the requirements of the consumer, in order to make it possible, in a short time and without an additional device, to heat up the pressure medium rapidly and as a result make more gentle and frequently also more comfortable operation of the consumer possible. Related to the driving operation, it is possible here to also use, for example, the stationary operation of the vehicle after starting up until driving off to preheat the pressure medium given an idling speed which is often raised for temperature reasons, in which case a load of this type on the engine in this phase may also be expedient for reducing the wear due to cold running and the functions of the devices dedicated to cleaning exhaust emissions with regard to the engine heating up more rapidly.

The invention thus provides a hydraulic system which can be advantageously used for different consumers, such as, for example, CVT transmissions or also power-assisted steering systems, there being many different possibilities of influence and good preconditions for gentle and also comfortable consumer operation despite the simple and energy-saving construction.

Further details and features of the invention emerge from the claims. Furthermore, the invention will be explained in the following text using an exemplary embodiment which illustrates a hydraulic system of the type according to the invention in a schematic representation.

The hydraulic system 1 comprises a variable displacement pump 2 which is situated in a circuit with a consumer 3, said circuit being formed by the pressure line 4, which starts from the variable displacement pump 2 and opens into the consumer 3, and the return line 5, which starts from the consumer 3 and is connected to the reservoir 7, the return line 5 in the exemplary embodiment being connected to the suction line 8 of the variable displacement pump 2 which starts from the reservoir 7. Lying in parallel with the delivery-side circuit described above is a short-circuit cycle having a line 9 which, starting from the section 10 of the pressure line 4, is connected to the reservoir 7 or the suction side of the variable displacement pump 2 via a pressure-relief valve 11 and opens into the suction line 8 in the exemplary embodiment.

The variable displacement pump 2 (shown only schematically in the drawing) is preferably configured as a vane cell pump which is known per se and can be adjusted by displacing its moving ring in its swept volume. For this purpose, the moving ring is acted on firstly by an energy store preferably configured as a spring, to be precise in its adjusting direction which increases the swept volume, and secondly in the opposite direction by a hydraulic adjusting device, the associated adjusting means being arranged within the pump housing enclosing the moving ring.

In the exemplary embodiment, this is illustrated functionally by a hydraulic adjusting device 16 which has an adjusting piston 13 (as part of the adjusting unit 12) which is acted on by the energy store illustrated as a spring 14 in the direction of increasing the swept volume, that is to say in the direction of running up the variable displacement pump 2, and which can be acted on hydraulically in the opposite direction to this, the adjusting piston 13 with the associated pressure chamber 15 illustrating the hydraulic adjusting device 16.

The consumer 3 is formed, by way of example and preferably, by an assembly of a motor vehicle (not shown in further detail), power-assisted steering systems, CVT transmissions or the like being considered inter alia as assemblies of this type. In the delivery-side feed line to the consumer 3, which is symbolized by the pressure line 4, there is a flow-control valve in the form of an adjustable throttle 17; on the return side, a pressure-regulating valve 18 is arranged in the return line 5 downstream of the consumer 3. The flow-control valve 17 configured as a throttling valve and the pressure-regulating valve 18 are in each case configured as controlled valves and in each case magnetic actuators 19 and 20 are provided in the exemplary embodiment as actuators which can be activated via a controller in a manner not shown in greater detail, parameters relevant to the vehicle or consumer being processed and converted into appropriate actuating signals in said controller.

The pressure-regulating valve 18 is configured as a sliding valve whose slide has pistons 21 and 22 which delimit an annular chamber 23 lying between them. A line section 24 of the return line 5 opens into the pressure-regulating valve 18 and following the pressure-regulating valve 18 continues in a line section 25, said line section 25 extending between the pressure-regulating valve 18 and the connection of the return line to the suction line 8. A throttling point 26 is situated in the line section 25, and a control line 27 branches off to the pressure chamber 15 of the adjusting device 16 upstream of the throttling point 26. Furthermore, a connecting line 28 is provided between the chamber 29 accommodating the spring 14 and the line section 25, the connecting line 28 being connected to the line section 25 downstream of the throttle 26. A line 30 which is connected to the reservoir 7 or the suction line 8 via the connecting line 28, and also to the chamber 29, opens into the connecting line 28, starting from the pressure-regulating valve 18.

The variable displacement pump 2 operates with a swept volume adapted to the consumer 3 and that part of the volume not received in each case by the consumer 3 is fed as an excess amount via the line section 24 to the pressure-regulating valve 18 and passes from there to the reservoir 7 or to the suction side of the pump 2 via the line section 25 of the return line 5. The volume output by the consumer 3, in particular the leakage and outflow volume, is fed back to the reservoir 7 either directly, as indicated by the connection 34, or via the return line 5.

The zero position for the pressure-regulating valve 18 can be adjusted by means of the spring 31, and the pressure chamber 15 of the adjusting device 16 is to be acted on by the excess fluid output from the pressure-regulating valve 18 via the branch line 27 which branches off from the line section 25, the geometric swept volume of the pump 2 thus being reduced. The chamber 29 on the rear side with respect to the adjusting piston 13 is for its part connected to the return line 5 via the connecting line 28, and also to the annular chamber 23 of the pressure-regulating valve 18 via the line 30 connected to the connecting line 28, so that, when the connection running via the pressure-regulating valve 18 between the line sections 24 and 25 is turned off and the variable displacement pump 2 is as a result adjusted in the direction of increasing the delivery amount by displacing the adjusting piston 13 by means of the spring 14 while reducing the volume of the pressure chamber 15 and displacing fluid via the branch line 27 as a result, the line 30 which opens into the connecting line 28 is pressurized via the annular chamber 23, the recirculation of the fluid displaced from the pressure chamber 15 to the chamber 29 thus being symbolically shown. Such recirculation is expedient within the context of the invention in order to make it possible to switch the pump 2 to a greater swept volume as rapidly as possible by means of the energy store in the form of the spring 14 if the pressure chamber 15 is relieved of pressure, and to be precise with as low a resistance as possible on the outflow side.

The invention thus provides a solution in which the swept volume of the pump 2 can be regulated to the demand of the consumer 3, related to the respectively prevailing boundary conditions. If there is a greater demand from the consumer or if this demand is signaled via the controller and the piston 21 is adjusted by the magnetic actuator 22 in the sense of reducing the cross section of flow between the line sections 24 and 25, the pressure in the chamber 15 is reduced and the pump 2 is adjusted in the direction of running it up by means of the spring 14 as energy store, the volume displaced from the pressure chamber 15 being displaced back into the line section 25 and fed into the circuit once again.

If there are sudden demand requirements from the consumer 3, the annular chamber 23 is moved so as to cover the line section 25 and the line 30 to a greater or lesser extent by appropriate displacement of the slide of the pressure-regulating valve 18, so that rapid and largely unthrottled flow back into the circuit is possible while bypassing the throttle 26, rapid running up of the variable displacement pump 2 thus being achieved when required, as the energy store formed by the spring 14 works counter to the depressurized pressure chamber 15 and makes sudden adjustment by means of the spring 14 possible given unthrottled outflow paths of correspondingly large dimensions, preferably connected on the opposite side to the pressure chamber 15, namely the chamber 29.

By means of the flow-control valve 17 which can be additionally activated by the magnetic actuator 19 and which makes it possible to set a minimum pressure, above which subjecting the consumer 3 to a load is permitted, by its piston 32 being supported by the spring 33, it is possible to vary this minimum pressure on the basis of a load being applied via the magnetic actuator 19, and it is also possible to shut off the line connection of the pressure line 4 to the consumer 3 to a greater or lesser extent. In this way, it is possible to at least partially eliminate, for example, the effects of temperature-dependent viscosity on the consumer 3 and its operation, and it is in particular also possible, in particular in conjunction with appropriate activation of the pressure-regulating valve 18, to set the variable displacement pump 2 to a delivery amount which is above the demand or requirements from the side of the consumer, so that the pressure-relief valve 11 situated in the short-circuit connection formed by the line 9 is activated, with the effect that the pressure medium is heated by the pressure decrease via the pressure-relief valve 11, it being possible to use said heating, for example during the starting phase at cold temperatures, to heat the pressure medium rapidly to temperatures which are sufficient for the requirements of the consumer for satisfactory, comfortable operation, even in view of the viscosity of the pressure medium. This can be utilized before the supply to the consumer 3 is opened or else in parallel to the supply of the consumer 3.

The invention thus provides a simple construction for a hydraulic system having a variable displacement pump and consumer, said construction making it possible, in addition to rapidly running up the variable displacement pump, also to utilize the pump energy for heating purposes as a result of the arrangement, provided in the return line from the consumer, of a controlled pressure-regulating valve in combination with a throttling valve situated in the delivery-side feed line to the consumer and a pressure-relief valve situated in a manner short-circuiting the variable displacement pump.

1. A hydraulic system having a variable displacement pump and a consumer, in particular an assembly of a motor vehicle, in which the variable displacement pump which is connected on the suction side to a reservoir and supplies, on the delivery side in the circuit, the consumer connected to the reservoir on the return side, and which is loaded by an energy store in an adjusting direction which increases the swept volume, and is acted on by a hydraulic adjusting device in the opposite direction, which adjusting device has pressure applied to it via a pressure-regulating valve counter to the stored force of the energy store as a function of the supply demand from the consumer or is connected to the reservoir so as to apply pressure, wherein the pressure-regulating valve is situated in the return line of the consumer to the reservoir and opens the return line of the consumer to the reservoir as a function of the pressure in order to apply pressure to the adjusting device, the return line having a throttle downstream of the pressure-regulating valve and being connected, between the pressure-regulating valve and throttling point, to the adjusting device via a branch line, said adjusting device being connected, in order to relieve the pressure on it, to the reservoir via an opened connecting path which leads via the pressure-regulating valve.

2. The hydraulic system as claimed in claim 1, wherein the connecting path comprises an unthrottled discharge path between the pressure-regulating valve and reservoir which is parallel to the throttled return line.

3. The hydraulic system as claimed in claim 1 or 2, wherein the pressure-regulating valve is activated as a function of system-relevant parameters, in particular operating parameters of the consumer.

4. The hydraulic system as claimed in claim 1 or 2, wherein a controlled flow-control valve, in particular a throttling valve, is arranged in the feed line to the consumer.

5. The hydraulic system as claimed in claim 1 or 2, wherein the variable displacement pump is designed as a vane cell pump.

6. The hydraulic system as claimed in claim 1 or 2, wherein the variable displacement pump is assigned a short-circuit cycle with a pressure-relief valve.

7. The hydraulic system as claimed in claim 6, wherein a pressure which is higher than the response pressure of the pressure-relief valve can be applied in a controlled manner to the feed line to the flow-control valve lying upstream of the consumer.

8. The hydraulic system as claimed in claim 6, wherein the pressure which is higher than the response pressure of the pressure-relief valve can be applied in a controlled manner via the flow-control valve.

9. The hydraulic system as claimed in claim 8, wherein the pressure upstream of the flow-control valve is higher than the operating pressure which is permissible for the consumer situated downstream of the flow-control valve.

10. The hydraulic system as claimed claim 6, wherein a heating operation takes place by means of pressure relief via the pressure relief valve.

11. The hydraulic system as claimed in claim 10, wherein the heating operation takes place before the operation of the consumer.

12. The hydraulic system as claimed in claim 10, wherein the heating operation takes place in parallel with the operation of the consumer.
